(19) United States
(12) Patent Application Publication
(10) Pub. No.: US 2013/0198097 A1
(43) Pub. Date: Aug. 1, 2013

(54) COMPENSATION PLAN SYSTEM WITH CROSS REFERENCING

(71) Applicants: Anadi UPADHYAYA, Kondapur (IN); Ty HAYDEN, Grand Junction, CO (US); Krishnaraj MAHADEVAN, Gudimalkapur Hyderabad (IN); Debasish DEB, Ameerpet Hyderabad (IN)

(72) Inventors: Anadi UPADHYAYA, Kondapur (IN); Ty HAYDEN, Grand Junction, CO (US); Krishnaraj MAHADEVAN, Gudimalkapur Hyderabad (IN); Debasish DEB, Ameerpet Hyderabad (IN)

(73) Assignee: ORACLE INTERNATIONAL CORPORATION, Redwood Shores, CA (US)

(21) Appl. No.: 13/358,861

(22) Filed: Jan. 26, 2012

(51) Int. Cl. G06Q 10/06

(52) U.S. Cl. 705/320

(57) ABSTRACT

One embodiment is directed to a computer program embodied on a computer readable medium. The computer program is configured to control a processor to execute instructions. The instructions include identifying, in a compensation system comprising a plurality of compensation plans, employee data that needs to be imported from at least one other compensation plan into a referring compensation plan. Each of the compensation plans comprises a plurality of columns. The instructions may further include selecting at least one column of the referring compensation plan that will receive the imported employee data from the at least one other compensation plan, and configuring details of the referring compensation plan using at least one property of the selected at least one column.

### FIELD

One embodiment is directed generally to a computer system, and, for example, to a computer system that manages and stores employee compensation data.

### BACKGROUND INFORMATION

Many corporations use compensation systems or software to manage the salaries, bonuses, and other types of compensation for their employees and staff. Based on several factors, such as work experience, work performance, position, etc., the compensation systems can be run to determine pay increases, bonuses, etc.

Some compensation systems, such as the “Compensation Workbench” from Oracle Corporation, provide an online application that enables end users, including line managers, to easily allocate compensation to employees that report to them. The allocated compensation may be of different types, such as salary increment/increase, stock allocation, bonus allocation, a combination of these compensation types (i.e., salary+bonus), as well as any other types of valuable compensation.

### SUMMARY

One embodiment is directed to a computer program embodied on a computer readable medium. The computer program is configured to control a processor to execute instructions. The instructions include identifying, in a compensation system comprising a plurality of compensation plans, employee data that needs to be imported from at least one other compensation plan into a referring compensation plan. Each of the compensation plans comprises a plurality of columns. The instructions may further include selecting at least one column of the referring compensation plan that will receive the imported employee data from the at least one other compensation plan, and configuring details of the referring compensation plan using at least one property of the selected at least one column.

### BRIEF DESCRIPTION OF THE DRAWINGS

FIG. 1 illustrates a system according to one embodiment of the invention;

FIG. 2 illustrates a user interface according to one embodiment;

FIG. 3 illustrates a user interface according to an embodiment;

FIG. 4 illustrates a user interface according to an embodiment;

FIG. 5 illustrates a user interface according to an embodiment;

FIG. 6 illustrates a user interface according to an embodiment;

FIG. 7 illustrates a user interface according to an embodiment;

FIG. 8 illustrates a user interface according to an embodiment;

FIG. 9 illustrates a user interface according to an embodiment;

FIG. 10 illustrates a user interface according to an embodiment;

FIG. 11 illustrates a user interface according to an embodiment; and

FIG. 12 illustrates a flow diagram of a method according to one embodiment.

### DETAILED DESCRIPTION

One embodiment is directed to a compensation system that includes a plurality of compensation plans. Each of the compensation plans may include a plurality of columns. For example, the columns may include name, job title, current annual salary, eligible salary, bonus amount, bonus percentage, bonus target amount, bonus target percentage, performance rating, and worker potential. Numerous other columns may be included in the compensation plans, and new columns may be added and customized by users. In an embodiment, the compensation system is capable of cross-referencing data from one compensation plan to another. For example, according to one embodiment, a referencing compensation plan can automatically import required employee data from another compensation plan by identifying and mapping a column of the other compensation plan to a column of the referencing compensation plan.

An organization may create one or more compensation plans to define and manage the allocation of different types of compensation to employees. Defined compensation plans are often linked to time periods, such as annual stock allocations or quarterly bonus allotments. As a result, in order to award compensation to their workforce, an organization may define compensation plans over the period of time. For example, an organization may define one compensation plan for the 2010 annual salary increase plan, and define another compensation plan for the 2011 annual salary increase plan, and so on. Multiple plans can also co-exist over the same time period, such as an annual salary increase plan for 2011 and an annual stock allocation plan for 2011.

Any defined compensation plan for a particular time frame contains numerous amounts of data related to employees. This employee data may be stored in human resources (“HR”) tables or may be derived from various sources using complex calculations defined by the business. As such, the stored employee data may then be presented in meaningful ways to line managers so that they can perform informed decision making. Therefore, each compensation plan contains critical data that an organization or business would like to re-use or share across multiple compensation plans that may span different time periods or the same time periods. According to one embodiment, a time period or frame may also be referred to as a “cycle.”

Hence, compensation systems need to cross-reference data from one compensation plan to another. Currently, this can be done via fast formula and batch jobs. However, solutions that utilize batch jobs or formulas may not be desirable because of the upfront cost of formula building, maintenance of the formula, overhead of the batch jobs, and lack of real time updates. Additionally, solutions that utilize batch jobs or formulas are not desirable because they require knowledge and expertise in areas which are not related to compensation and, therefore, require support and technical assistance, which creates overhead in terms of time and cost.

Accordingly, embodiments of the invention provide a compensation system that enhances a column defaulting feature to allow plan cross-reference of data in a real-time manner. Embodiments of the invention are able to accomplish this without the use of formulas or batch jobs. As a result, the compensation system according to embodiments of the invention will provide the end users (i.e., managers) the ability to see data combined from multiple plans.

Embodiments of the invention can also be used to create a total compensation reporting plan, which provides a complete view of compensation data across all plans, with all of the features that the compensation system has to offer such as sorting, filtering, exporting, etc., as well as a consolidated compensation statement.

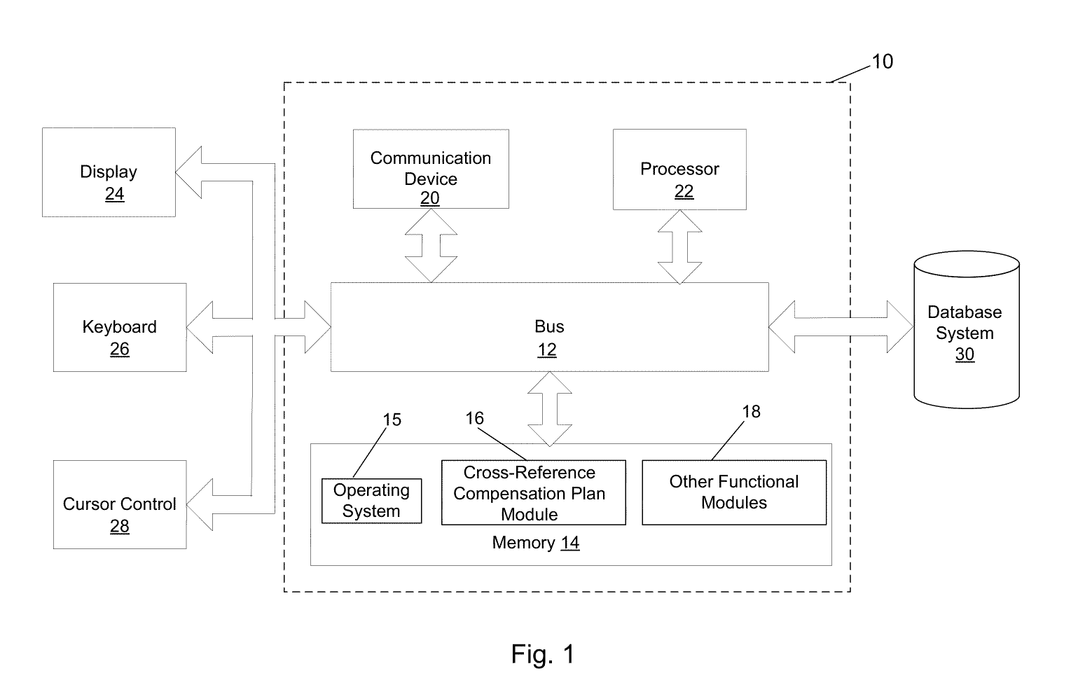

FIG. 1 illustrates a block diagram of a system 10 configured to implement a compensation system, according to one embodiment. System 10 includes a bus 12 or other communications mechanism for communicating information between components of system 10. Alternatively, the components of system 10 may communicate with each other directly without the use of bus 12.

System 10 also includes a processor 22, coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer readable media. System 10 further includes a communication device 20, such as a network interface card or other communications interface, to provide access to a network. As a result, a user may interface with system 10 directly or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information or data to a user, such as maps or diagrams, as will be discussed in more detail below. A keyboard 26 and a cursor control device 28, such as a computer mouse, are further coupled to bus 12 to enable a user to interface with system 10.

Processor 22 and memory 14 may also be coupled via bus 12 to a database system 30 and, thus, may be able to access and retrieve information stored in database system 30. Although only a single database is illustrated in FIG. 1, any number of databases may be used in accordance with certain embodiments. In some embodiments, database system 30 may store information related to employees and their compensation, such as salaries, bonuses, stock options, and any other relevant employee and/or compensation information.

In one embodiment, memory 14 stores software modules that provide functionality when executed by processor 22. The modules may include an operating system 15 that provides operating system functionality for system 10. The memory may also store a cross-reference compensation plan module 16, which can provide the functionality for cross-referencing across different compensation plans of the compensation system, according to one embodiment. System 10 may also include one or more other functional modules 18 to provide additional functionality. Functional modules 18 may include, for example, a human resources module or an enterprise resource planning (“ERP”) system.

Database system 30 may include a database server and any type of database, such as a relational or flat file database. Database system 30 may store attributes related to employees and compensation. Database system 30 may also store any other data required by the cross-reference compensation plan module 16, or data associated with system 10 and its associated modules and components.

In certain embodiments, cross-reference compensation plan module 16, and other functional modules 18 may be implemented as separate physical and logical units or may be implemented in a single physical and logical unit. Furthermore, in some embodiments, cross-reference compensation plan module 16, and other functional modules 18 may be implemented in hardware, or as any suitable combination of hardware and software.

In one embodiment, cross-reference compensation plan module 16 is configured to control system 10, when defining a compensation plan, to identify which details of employee data should be referred to across compensation plans. In other words, while system 10 is defining or creating a compensation plan, cross-reference compensation plan module 16 can identify the employee data from columns of other compensation plans that need to be imported into the compensation plan currently being created. The employee data may be from a current time period, year or cycle, or may be from previous years or cycles.

In an embodiment, cross-reference compensation plan module 16 is configured to determine whether a cross-reference to another compensation plan is required. If such a cross-reference to another compensation plan is not required, then system 10 will proceed as normal without defining a cross-reference to another compensation plan. If, however, it is determined by cross-reference compensation plan module 16 that a cross-reference to another compensation plan is required, then cross-reference compensation plan module 16 is configured to select one or more columns from the compensation plan being created to hold the data that will be cross-referenced or imported from the other compensation plans. In one embodiment, the compensation plan being created may include more than 250 columns of data.

According to certain embodiments, cross-reference compensation plan module 16 is further configured, for each of the selected columns, to configure the details of the compensation plan being created using one or more properties of the selected column. Cross-reference compensation plan module 16 may then identify and select the name of the other compensation plan(s) from which employee data will be cross-referenced or imported. Cross-reference compensation plan module 16 can also select the associated time period or cycle for the other compensation plan from which the employee data will be imported. Cross-reference compensation plan module 16 may then select the columns from the identified other compensation plan(s) and associated time period that need to be mapped to the selected columns from the compensation plan being created. In this manner, cross-reference compensation plan module 16 configures a column of the compensation plan being created to cross-reference a column of another compensation plan. The process may then be repeated for all columns that require cross-referencing.

Once all the columns that require cross-referencing of data from columns of other compensation plans have been configured, the data will automatically be updated and imported in real-time. For instance, if data in one of the other compensation plans being referenced is updated, the data will also be automatically updated in the compensation plan in real-time.

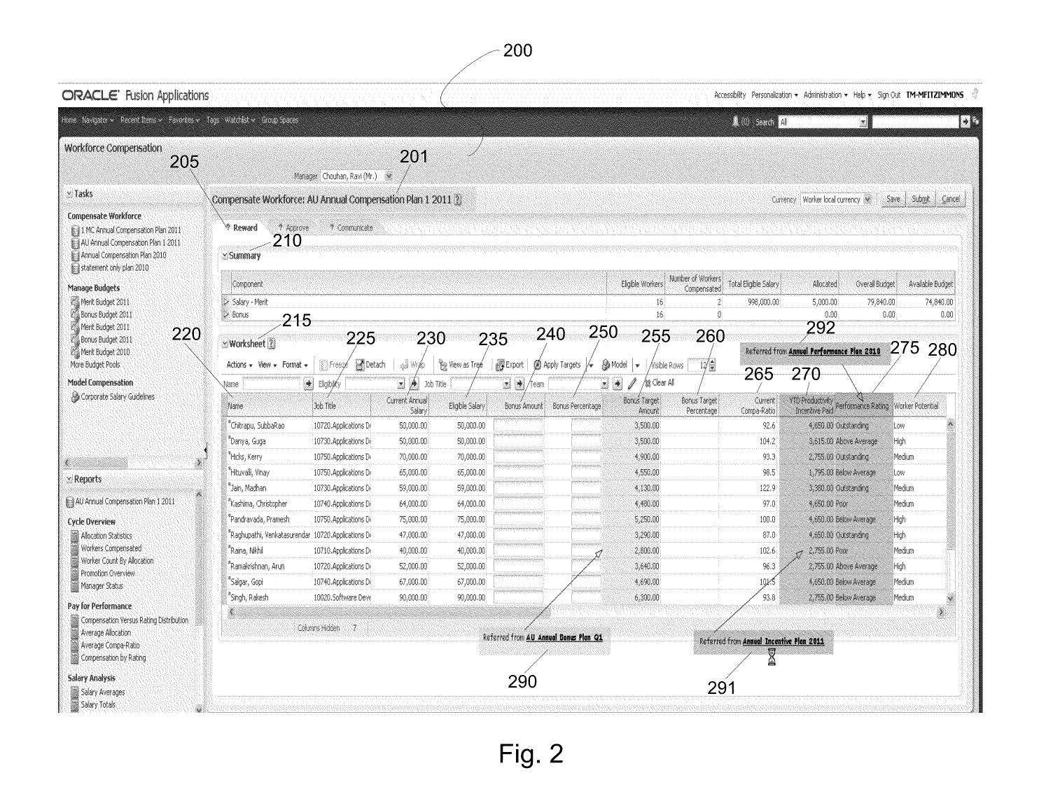

FIG. 2 illustrates an example of compensation plan 200 that includes columns of data imported from other compensation plans. In an embodiment, compensation plan 200 may be provided by a compensation system, such as system 10 discussed above.

In the example illustrated in FIG. 2, the compensation plan 200 is the “Annual Compensation Plan 1 2011” as displayed in the plan name section 201. FIG. 2 shows the Reward tab 205 of the “Annual Compensation Plan 1 2011”. The Reward tab 205 includes a summary section 210 and a worksheet section 215. In one embodiment, summary section 210 may include a summary of the salary and bonus information provided in detail by worksheet section 215.

The worksheet section 215 includes a plurality of columns displaying employee compensation data. For example, the columns of worksheet section 215 may include name 220, job title 225, current annual salary 230, eligible salary 235, bonus amount 240, bonus percentage 250, bonus target amount 255, bonus target percentage 260, current compa-ratio 265, year-to-date productivity incentive paid 270, performance rating 275, and worker potential 280. It should be noted that the columns of the compensation plans are not only limited to those illustrated in worksheet section 215 of FIG. 2, and that numerous other columns related to employee compensation data may be included according to other embodiments.

As illustrated in FIG. 2, in this example, bonus target amount column 255 includes employee data that is imported from another compensation plan, which is the “Annual Bonus Plan Q1” (indicated at 290). Similarly, year-to-date productivity incentive paid column 270 includes employee data that is imported from another compensation plan, which in this example is “Annual Incentive Plan 2011” (indicated at 291). Performance rating column 275 of FIG. 2 also includes employee data that is imported from the “Annual Performance Plan 2010” compensation plan (indicated at 292). As a result, all pertinent data will be automatically available and updated in real-time with access to all of the features the compensation plan may offer, such as sorting, filtering, exporting, etc.

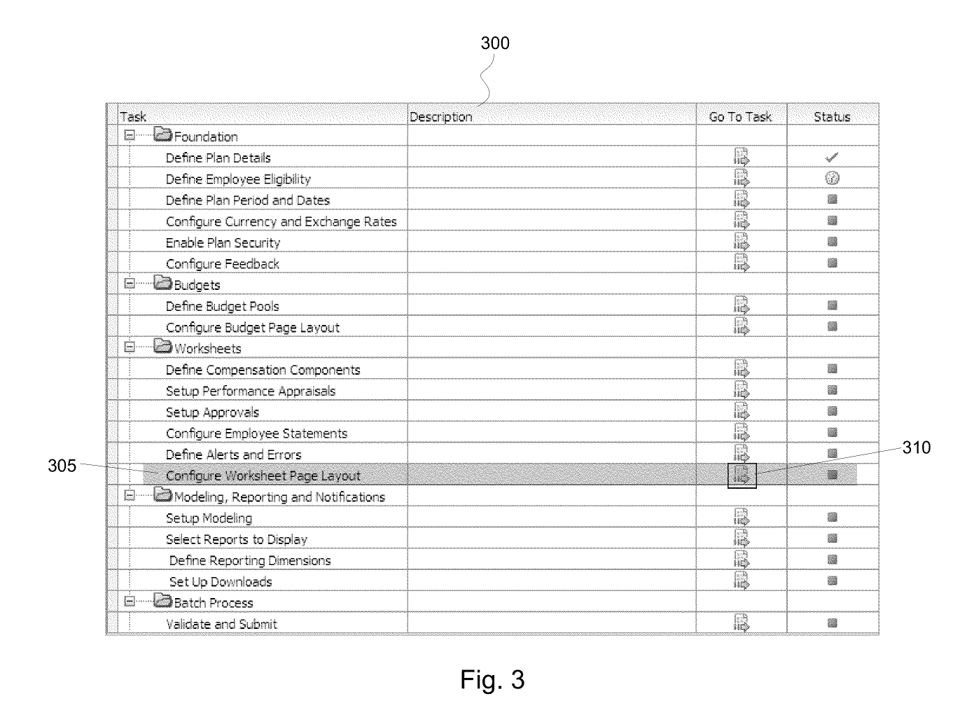

FIG. 3 illustrates an example of a setup user interface 300 that may be provided by the compensation system and that is used to begin the configuration of a compensation plan for cross-reference to other compensation plans. In the example of FIG. 3, to begin configuration of a compensation plan, a user, such as a compensation administrator, can select the configure worksheet page layout line 305 by selecting the go-to-task button 310.

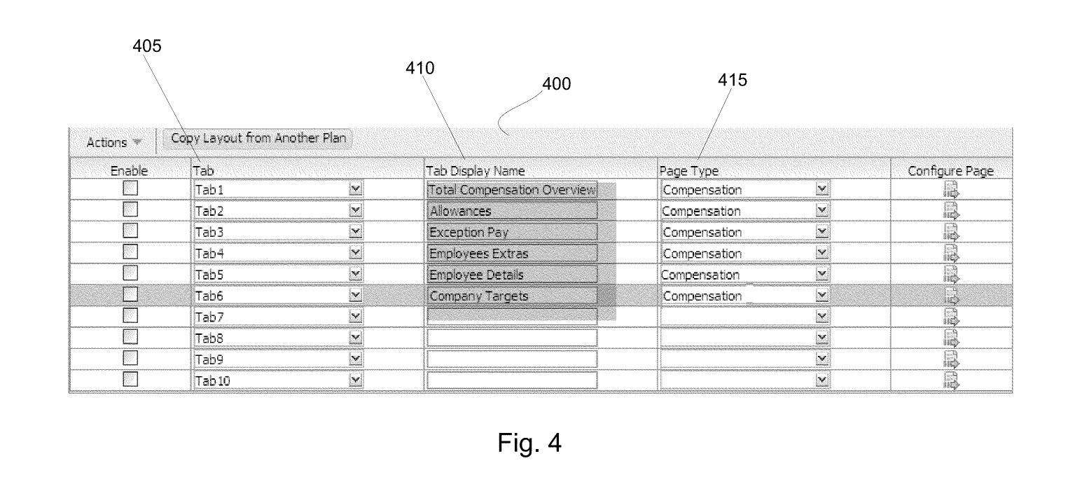

The compensation system may also provide a worksheet tab user interface 400, as illustrated in FIG. 4. A compensation administrator may use the worksheet tab user interface 400 to select the tab 405, the tab's associated display name 410, and the page type 415 for display in the compensation plan 200. Each tab 405 may include a plurality of columns, which can include data that is cross-referenced to or form other compensation plans.

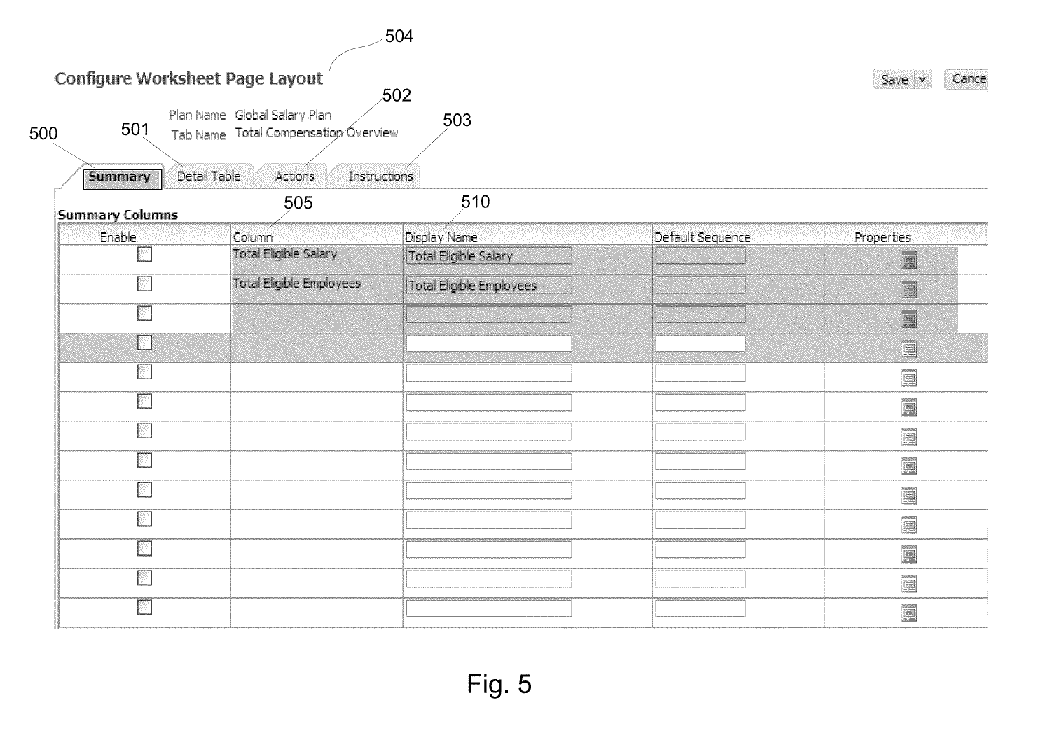

FIG. 5 illustrates a configure page worksheet layout user interface 504. In this example, the configure page worksheet layout user interface 504 includes a summary tab 500, detail table tab 501, actions tab 502, and instructions tab 503. The elements of the summary tab 500 is illustrated in FIG. 5 and includes summary columns, such as column 505 and display name 510. Using the configure page worksheet layout user interface 504 a compensation administrator, for example, can choose the required columns for the summary section 210 of compensation plan 200 in FIG. 2.

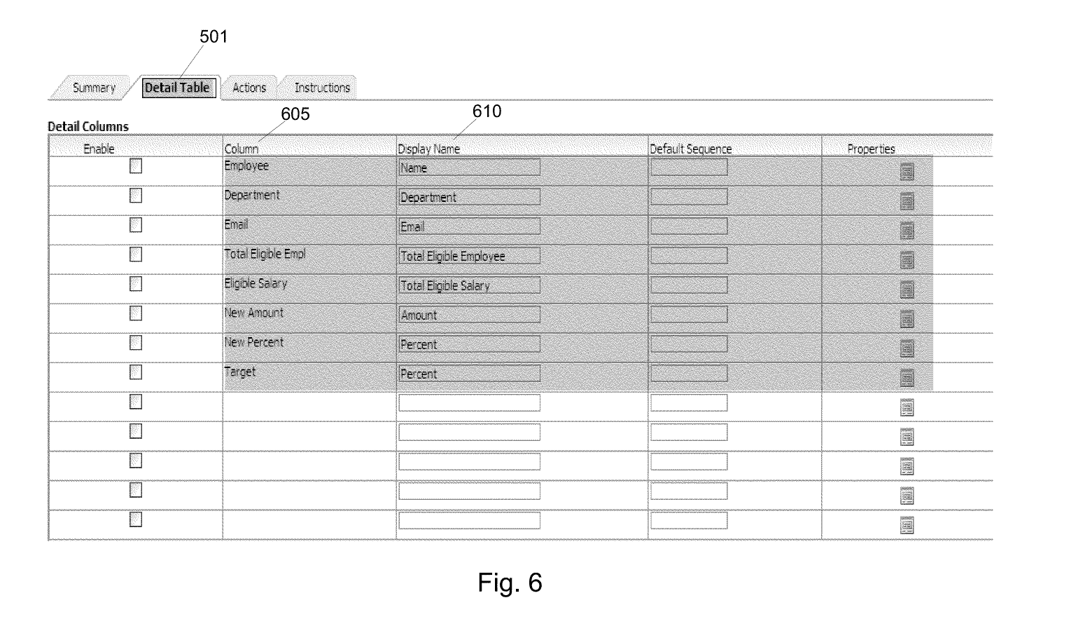

FIG. 6 illustrates the elements of detail table tab 501 of the configure page worksheet layout user interface 504 of FIG. 5. Under the detail table tab 501, a compensation administrator, for example, can select the required columns for the worksheet section 215 of compensation plan 200. In the example illustrated in FIG. 6, the columns selected are listed in column 605 and include employee, department, email, total eligible employee, eligible salary, new amount, new percent, and target. Display name column 610 allows the administrator to enter the display name that is displayed for the associated column.

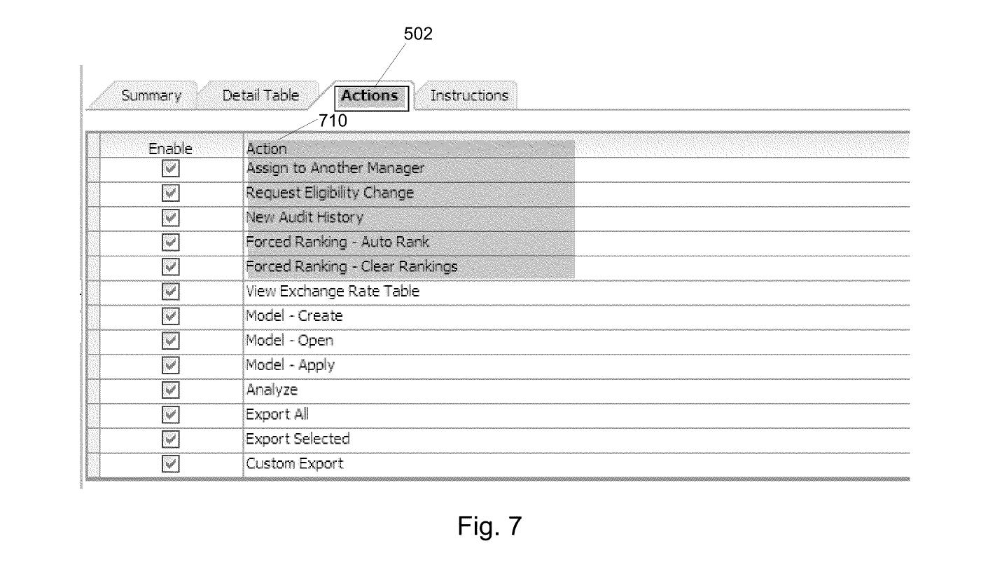

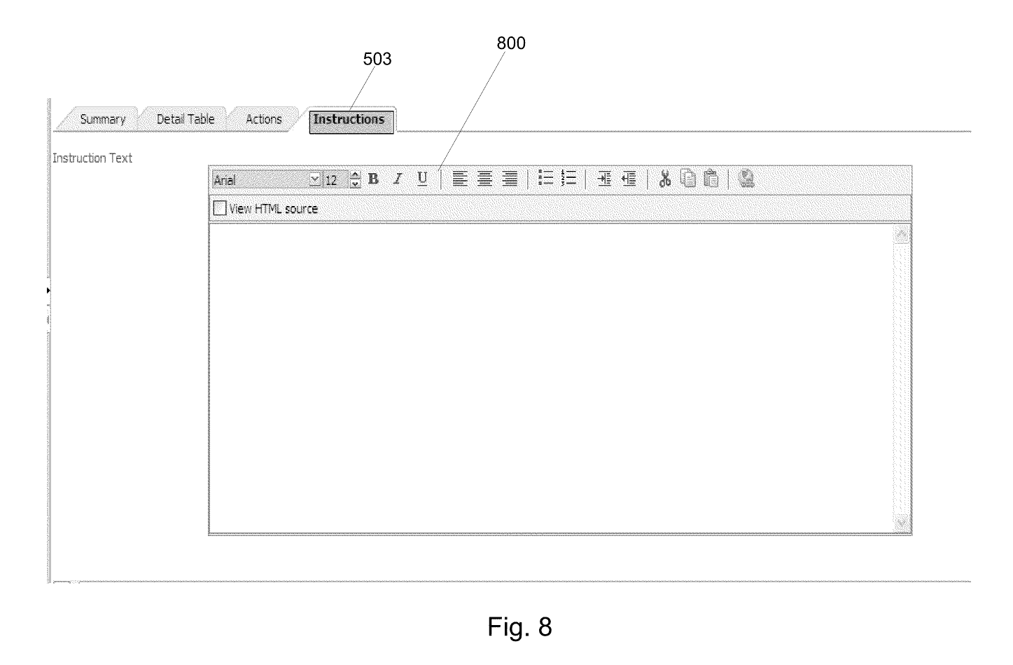

FIG. 7 illustrates the elements of actions tab 502 of the configure page worksheet layout user interface 504 of FIG. 5. In this embodiment, under the actions tab 502, an administrator can enable required actions 710, if any. FIG. 8 illustrates the elements of instructions tab 503 of the configure page worksheet layout user interface 504 of FIG. 5. Under the instructions tab 503, the administrator can provide instructions for an end user of the compensation plan 200 via text box 800.

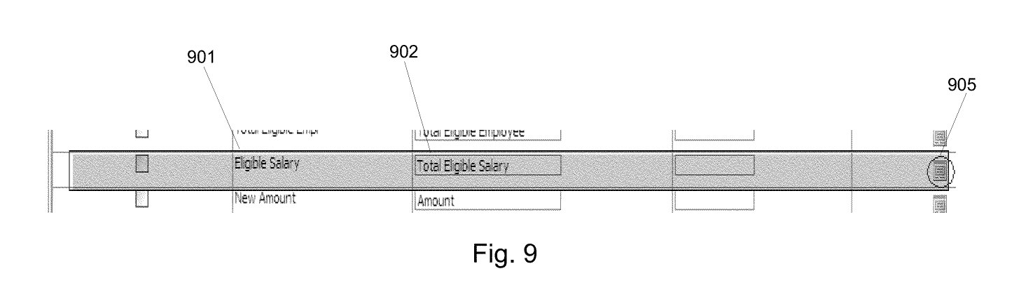

FIG. 9 illustrates a section of the detail table tab 501 of the configure page worksheet layout user interface 504 shown in FIG. 6. Using properties button 905, an administrator can define different properties for columns selected for display in compensation plan 200. In the example of FIG. 9, properties button 905 is associated with eligible salary column 901, which has total eligible salary display name 902. For instance, by selecting properties button 905 associated with eligible salary column 901, an administrator can configure the eligible salary of compensation plan 200 to map to the eligible salary from another compensation plan.

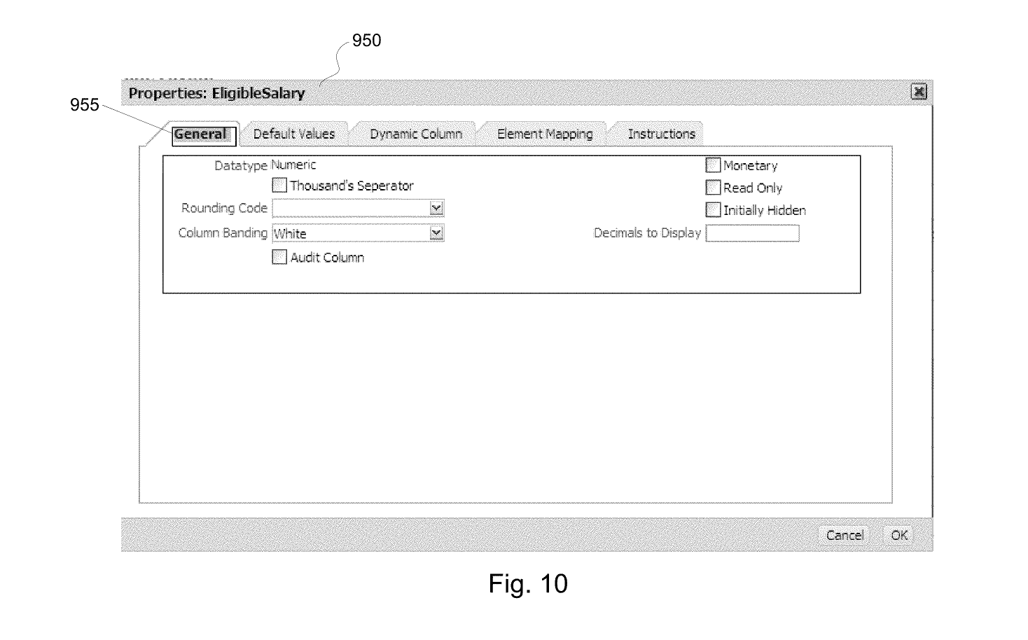

FIG. 10 illustrates an example of an eligible salary properties window 950 which will be displayed when properties button 905 of FIG. 9 is selected. As illustrated in FIG. 10, eligible salary properties window 950 includes a general tab 955 that displays properties for the data type of the eligible salary column and options for display of the eligible salary column.

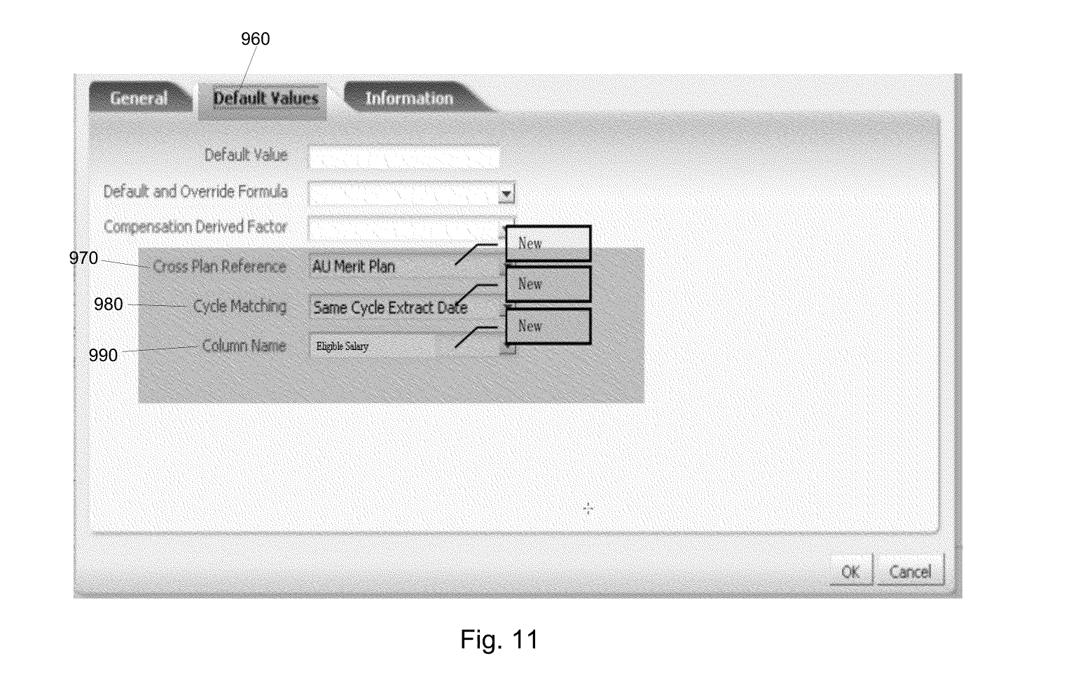

FIG. 11 illustrates an example of the default values tab 960 of properties window 950. The default values tab 960 allows an administrator to select or identify the compensation plan from which data is to be referenced or imported. In other words, the default values tab 960 allows an administrator to define the mapping between a column of compensation plan 200 and another compensation plan. In an embodiment, as shown in FIG. 11, cross plan reference section 970 is used to select the compensation plan from which data is to be imported.

In the example of FIG. 11, the data is cross-referenced from the “AU Merit Plan” compensation plan. Cycle matching section 980 allows an administrator to identify the time period of the cross-referenced compensation plan over which data is to be imported. In this example, cycle matching section 980 identifies the “same cycle extract date” indicating that the data should be for the same time period as the referencing compensation plan 200. Column name section 990 identifies the column of the “AU Merit Plan” compensation plan that should be imported. In this example, the column identified by column name section 990 is the “eligible salary” column.

Therefore, as a result of the mapping performed in default values tab 960 of properties window 950, eligible salary column 235 of compensation plan 200 will cross-reference the eligible salary column of the “AU Merit Plan” compensation plan over the same time period of compensation plan 200. It should be noted that FIG. 11 illustrates one possible example of a mapping for purposes of explanation, and that innumerable other mappings and configurations are possible according to other embodiments of the invention.

As a result of the configurations provided by embodiments of the present invention, all the enabled and configured columns in one compensation plan will be available for reference in other compensation plans. Additionally, any number of compensation plans can reference the same plan and column. Further, there is no limit to the number of references a column can have. For example, column A in compensation plan A can be referenced in both plan B and plan C.

Further, embodiments of the invention, as implemented by system 10, can prevent the mapping of any invalid type of data which would result in an unexpected outcome. For example, a numeric column, such as “Previous Year Bonus” cannot be mapped to a column called “Promotion Effective Date,” as system 10 will prevent the mapping of a numeric column to a date column. System 10 is able to handle more than 250 columns of different data types, such as numeric, date, string, or list columns.

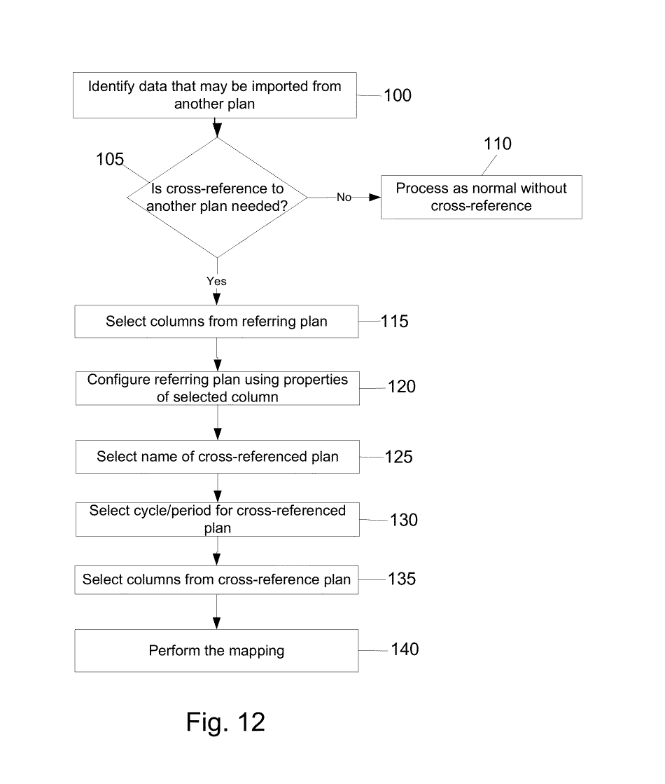

FIG. 12 illustrates a flow diagram of a method for creating compensation plan cross-references, according to one embodiment. In certain embodiments, the functionality of the flow diagram of FIG. 12, is implemented by software stored in memory or other computer readable or tangible media, and executed by a processor. In other embodiments, the functionality may be performed by hardware (e.g., through the use of an application specific integrated circuit (ASIC), a programmable gate array (PGA), a field programmable gate array (FPGA), etc.), or any combination of hardware and software.

Referring to FIG. 12, the method includes, at 100 identifying the employee data from other compensation plans that may be cross-referenced or imported into the compensation plan currently being created. At 105, the method includes determining whether a cross-reference to another compensation plan is required. If such a cross-reference to another compensation plan is not required, then, at 110, the method will proceed without defining a cross-reference to another compensation plan. If, however, it is determined that a cross-reference to another compensation plan is required, then, at 115, the method includes selecting one or more columns from the compensation plan being created to hold the data that will be cross-referenced or imported from the other compensation plans.

The method then includes, at 120, configuring the details of the compensation plan being created using one or more properties of the selected column. At 125, the method includes identifying and selecting the name of the other compensation plan(s) from which employee data will be cross-referenced or imported. The method then includes, at 130, selecting the associated time period or cycle for the other compensation plan from which the employee data will be imported. Data can be from compensation plans for the same time period or from previous years/cycles. At 135, the method also includes selecting the column(s) from the identified other compensation plan(s) and associated time period that need to be mapped to the selected columns from the compensation plan being created. The method then includes, at 140, performing the mapping of the selected columns from the other compensation plan(s) to the selected column(s) from the compensation plan being created. According to an embodiment, the method may be repeated for each of the columns of the compensation plan being created that require a mapping to another compensation plan.

As a result of certain embodiments, one compensation plan data can be referenced across multiple plans. Additionally, embodiments eliminate the use of fast formulas or any user defined code previously required to cross-reference plan data. Similarly, embodiments eliminate the use of any batch jobs for data load for cross-reference and data synchronization, and eliminate the use of legacy ways of data reference. Data and/or columns from one compensation plan can be referred to in other compensation plans on real time basis. Furthermore, any number of plans can reference the same plan and column, and referenced columns can be used as general columns as well as in other calculations. Embodiments of the invention further eliminate the need for help from third party agents for compensation administrators thereby reducing the overall implementation time for a compensation plan, which results in time and cost saving for customers.

It should be noted that many of the functional features described in this specification have been presented as modules, units, applications or the like, in order to more particularly emphasize their implementation independence. For example, a module or unit may be implemented as a hardware circuit comprising custom VLSI circuits or gate arrays, off-the-shelf semiconductors such as logic chips, transistors, or other discrete components. A module or unit may also be implemented in programmable hardware devices such as field programmable gate arrays, programmable array logic, programmable logic devices or the like.

Modules or units may also be partially implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve its stated purpose.

Indeed, a module of executable code or algorithm could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer program embodied on a computer readable medium, the computer program configured to control a processor to execute instructions, comprising:
identifying, in a compensation system comprising a plurality of compensation plans, employee data that needs to be imported from at least one other compensation plan into a referring compensation plan, wherein each of the compensation plans comprises a plurality of columns;
selecting at least one column of the referring compensation plan that will receive the imported employee data from the at least one other compensation plan; and
configuring details of the referring compensation plan using at least one property of the selected at least one column.

2. The computer program according to claim 1, further comprising:
selecting a name of the at least one other compensation plan from which the employee data is imported.

3. The computer program according to claim 2, further comprising:
selecting an associated time period for the at least one other compensation plan from which the employee data is imported.

4. The computer program according to claim 3, further comprising:
selecting at least one column, from the at least one other compensation plan and the associated time period, for mapping to the selected at least one column from the referring compensation plan.

5. The computer program according to claim 4, further comprising:
performing the mapping of the at least one column of the at least one other compensation plan to the selected at least one column of the referring compensation plan.

6. The computer program according to claim 1, wherein the plurality of columns comprises at least one of name, job title, current annual salary, eligible salary, bonus amount, bonus percentage, bonus target amount, bonus target percentage, performance rating, worker potential, or any column containing any worker information that can be referenced.

7. The computer program according to claim 2, wherein the selecting of the name of the at least one other compensation plan from which the employee data is imported comprises selecting the name in a cross plan reference section of a properties window.

8. The computer program according to claim 1, wherein the employee data imported from the at least one other compensation plan comprises employee data from a current time period or employee data from a previous time period.

9. A method, comprising:
identifying, in a compensation system comprising a plurality of compensation plans, employee data that needs to be imported from at least one other compensation plan into a referring compensation plan, wherein each of the compensation plans comprises a plurality of columns;
selecting at least one column of the referring compensation plan that will receive the imported employee data from the at least one other compensation plan; and
configuring details of the referring compensation plan using at least one property of the selected at least one column.

10. The method according to claim 9, further comprising:
selecting a name of the at least one other compensation plan from which the employee data is imported.

11. The method according to claim 10, further comprising:
selecting an associated time period for the at least one other compensation plan from which the employee data is imported.

12. The method according to claim 11, further comprising:
selecting at least one column, from the at least one other compensation plan and the associated time period, for mapping to the selected at least one column from the referring compensation plan.

13. The method according to claim 12, further comprising:
performing the mapping of the at least one column of the at least one other compensation plan to the selected at least one column of the referring compensation plan.

14. The method according to claim 9, wherein the plurality of columns comprises at least one of name, job title, current annual salary, eligible salary, bonus amount, bonus percentage, bonus target amount, bonus target percentage, performance rating, or worker potential.

15. The method according to claim 9, wherein the employee data imported from the at least one other compensation plan comprises employee data from a current time period or employee data from a previous time period.

16. An apparatus, comprising:
a processor; and
a cross-reference compensation plan module, wherein the cross-reference compensation plan module and the processor are configured to control the apparatus to
identify, in a compensation system comprising a plurality of compensation plans, employee data that needs to be imported from at least one other compensation plan into a referring compensation plan, wherein each of the compensation plans comprises a plurality of columns;
select at least one column of the referring compensation plan that will receive the imported employee data from the at least one other compensation plan; and
configure details of the referring compensation plan using at least one property of the selected at least one column.

17. The apparatus according to claim 16, wherein the cross-reference compensation plan module and the processor are further configured to control the apparatus to:
select a name of the at least one other compensation plan from which the employee data is imported.

18. The apparatus according to claim 17, wherein the cross-reference compensation plan module and the processor are further configured to control the apparatus to:
select an associated time period for the at least one other compensation plan from which the employee data is imported.

19. The apparatus according to claim 18, wherein the cross-reference compensation plan module and the processor are further configured to control the apparatus to:
select at least one column, from the at least one other compensation plan and the associated time period, for mapping to the selected at least one column from the referring compensation plan.

20. The apparatus according to claim 19, wherein the cross-reference compensation plan module and the processor are further configured to control the apparatus to:
perform the mapping of the at least one column of the at least one other compensation plan to the selected at least one column of the referring compensation plan.

21. The apparatus according to claim 16, wherein the plurality of columns comprises at least one of name, job title, current annual salary, eligible salary, bonus amount, bonus percentage, bonus target amount, bonus target percentage, performance rating, or worker potential.

22. The apparatus according to claim 16, wherein the employee data imported from the at least one other compensation plan comprises employee data from a current time period or employee data from a previous time period.

23. The apparatus according to claim 16, wherein the employee data imported from the at least one other compensation plan is automatically updated on a real time basis whenever there is any change to the at least one other compensation plan.
